(19) United States
(12) Patent Application Publication
(10) Pub. No.: US 2020/0340626 A1
(43) Pub. Date: Oct. 29, 2020

(54) A Fault-Tolerant Cryogenically Cooled System

(71) Applicant: Siemens Healthcare Limited, Camberley (GB)

(72) Inventors: Simon Chorley, Oxfordshire (GB); Adam Paul Johnstone, Oxfordshire (GB); Michael Simpkins, Holmer Green, High Wycombe, Buckingh (GB)

(73) Assignee: Siemens Healthcare Limited, Camberley (GB)

(21) Appl. No.: 16/642,983

(22) PCT Filed: Jul. 31, 2018
(86) PCT No.: PCT/EP2018/070707

§ 371 Date: Feb. 28, 2020

(30) Foreign Application Priority Data
Aug. 30, 2017 (GB) 1713851.2

(51) Int. Cl. F17C 13/00; F25B 9/10; F17C 3/08; H01F 6/06

(52) U.S. Cl. CPC F17C 13/007; H01F 6/06; F17C 3/085; F25B 9/10

(57) ABSTRACT

A fault-tolerant cryogenically cooled system including an outer vacuum chamber defining a vacuum region in its interior volume; a cryogenic refrigerator; equipment to be cooled, housed within the vacuum region; a free volume delimited within the vacuum region and containing a cryogen; a cold plate exposed to the free volume and thermally linked to the equipment to be cooled; a heat exchanger thermally linked to a coldest stage of the refrigerator and exposed to the free volume; a cryogen buffer vessel delimiting a buffer volume; and a passage linking the buffer volume with the free volume.

### TECHNICAL FIELD

The present disclosure relates to cooled equipment which is cooled by a cryogen at its boiling point.

In particular, it relates to cooled equipment maintained at a cryogenic temperature by a small volume of cryogen which is actively cooled. In preferred embodiments, the cooled equipment is a superconducting magnet for an MRI system.

### BACKGROUND

The following terms in this document may be interpreted as follows:

Up-time: time periods where the cooled equipment is in an operational state for the end user.

Down-time: time periods where the cooled equipment is not in an operational state for the end user.

Ride-through: the periods where active cooling has failed but a cooled system is maintaining its cooled state. In the context of a superconducting magnet, current continues to flow in superconducting coils during ride-through. The magnet may be maintained in a cooled state by boil-off of liquid cryogen.

Down-time ends when active cooling is restored provided that magnet current has been maintained in the superconducting magnet, and up-time commences. Down-time is preferably kept as short as possible, preferably less than one hour.

Ride-through ends when the magnet current ceases, or the magnet quenches or significantly warms up. In case of quench or significant warming, the resultant down-time will be much longer than one hour. Down-time needs to be avoided as it ultimately impacts customer financial performance.

FIG. 1 shows a conventional arrangement of a cryostat including a cryogen vessel 12. A cooled superconducting magnet 10 for an MRI system is provided within cryogen vessel 12, itself retained within an outer vacuum chamber (OVC) 14 which defines a vacuum region in its interior volume.

One or more thermal radiation shields 16 are provided in the vacuum space between the cryogen vessel 12 and the outer vacuum chamber 14. In some known arrangements, a refrigerator 17 is mounted in a refrigerator sock 15 located in a turret 18 provided for the purpose, towards the side of the cryostat. Alternatively, a refrigerator 17 may be located within access turret 19, which retains access neck (vent tube) 20 mounted at the top of the cryostat. The refrigerator 17 provides active refrigeration to cool cryogen gas within the cryogen vessel 12, in some arrangements by recondensing it into a liquid. The refrigerator 17 may also serve to cool the radiation shield 16. As illustrated in FIG. 1, the refrigerator 17 may be a two-stage refrigerator. A first cooling stage is thermally linked to the radiation shield 16, and provides cooling to a first temperature, typically in the region of 25-100K. A second cooling stage provides cooling of the cryogen gas to a much lower temperature, typically in the region of 2.5-10K.

A separate vent path (“auxiliary vent”) (not shown in FIG. 1) may be provided as a fail-safe vent in case of blockage of the vent tube 20.

Recently, developments have been made in reducing the quantity of cryogen required in such cryostats. This has been particularly the case for helium cryogen, since helium is scarce and expensive. Some cryostats have been proposed which contain a relatively small amount of cryogen in the cryogen vessel 12, while other cryostats have been proposed which dispense with the cryogen vessel altogether, and do not rely on direct contact between cryogen and the cooled equipment. Such arrangements may be referred to as “dry” cryostats, or “dry” magnets, although some cryogen liquid may be involved in the associated cooling arrangements.

A consequence of reducing the amount of cryogen material in a cryostat (known as “cryogen inventory”) is in reducing the thermal inertia of the cooled equipment. For example, where a large volume of liquid cryogen is provided in a cryogen vessel and providing cooling to cooled equipment, the cooled equipment will remain at the temperature of the boiling point of the cryogen until all of the cryogen has boiled off, even where an active cooling arrangement such as refrigerator 17 has failed, for example due to a fault in the refrigerator itself, or failure of an electrical power supply, or failure of other services, such as cooling water to a compressor required by the refrigerator. On the other hand, where only a small volume of liquid cryogen is provided, the cooled equipment will remain at the temperature of the boiling point of the cryogen only for a short time until all of the cryogen has boiled off.

Such reduction in thermal inertia leads to a reduction in “uptime”—the availability of the cooled equipment for use, since any interruption to the active cooling arrangements such as refrigerator 17 is more likely to continue until after all cryogen has boiled, leading to a rise in temperature of the cooled equipment. A reduced cryogen inventory as described will cause reduced ability of cooled equipment to withstand short term failures of active refrigeration without warming of the cooled equipment above the boiling point of the cryogen.

Conventionally, where a large volume of cryogen has been employed in a cryogen vessel, the cooled equipment has correspondingly had a very large thermal inertia. Any unreliability in the active cooling arrangements such as refrigerator 17 may be tolerated where the system has a large thermal inertia, but will unacceptably risk heating of the cooled equipment in the case of a system with small thermal inertia.

A disadvantage of providing large thermal inertia by providing a large mass of cryogen is that cooling effected by boiling off of the cryogen may mean loss of the cryogen, which will have to be replaced at significant 5 expense.

Conventionally, arrangements of low thermal inertia have dealt with failure of active refrigeration in various ways, some of which will now be described. The system may be allowed to safely fail. For example, a small superconducting magnet used for MRI may quench and be re-cooled afterwards, but this gives rise to significant down-time Re-cooling of the magnet from a significantly elevated temperature, e.g. −60K could take longer than 24 hours to achieve. Current would have to be re-introduced into the magnet, and various operating checks would need to be performed before the magnet could re-enter service, so this option should not be undertaken lightly. The cooled equipment may automatically be placed into a safe mode. For example larger MRI magnets may be automatically de-energized in a controlled manner when a cooling failure occurs. This gives rise to significant down-time, as the magnet may have to be provided with a fresh quantity of cryogen, and cooled from some elevated temperature. However, the magnet down-time in such case should be shorter than for the previously-described option because de-energizing the magnet in a controlled manner allows stored energy to be extracted rather than being dissipated in heating the magnet. The magnet stays at a lower temperature than in the previous examples, but may warm up slowly over many days if left uncooled. Where the magnet is allowed to quench, the energy stored in the magnet energy is released as heat into the magnet, and must be extracted by cooling. Back-up site infrastructure may be provided, for example redundant cryogenic refrigerators, backup water and power to provide active cooling in case of failure of other active cooling arrangements. A further, or alternative, arrangement is to include high heat capacity materials within the structure to add thermal inertia which serves to reduce the rate of temperature rise for a given thermal influx.

The solutions proposed so far tend to be expensive to implement, or still cause long periods of down-time, or both.

### SUMMARY

The present disclosure addresses the problem of fault tolerance in active cooling of cooled equipment of low thermal inertia by providing a self-contained fault-tolerant system which is capable of withstanding short term failure of an associated active cooling arrangement, such as a cryogenic refrigerator.

The following prior art documents provide some technical 15 background to the present disclosure: U.S. Pat. No. 6,807,812, US2008/0216486, US5015/0233609, US2017/0038100, CN106683821-A, “Cool-down acceleration of G-M cryocoolers with thermal oscillations passively damped by helium”, RI Webber and I Delmas, IoP Conf. Series: Materials Science and Engineering 101 (2015) 012137 doi:10.1088/1757-899X/101/1/012137.

The present disclosure accordingly provides a fault-tolerant cryogenically cooled system as defined in the appended claims.

### BRIEF DESCRIPTION OF THE FIGURES

The above, and further, objects, advantages and characteristics of the 25 present disclosure will become more apparent from the following description of certain embodiments thereof, in conjunction with the appended drawings, wherein:

FIG. 1 shows a conventional arrangement of a superconducting 30 magnet cooled by partial immersion in a liquid cryogen;

FIG. 2 shows a first exemplary embodiment of the present disclosure;

FIG. 3 shows a second exemplary embodiment of the present disclosure; and

FIG. 4 shows a third exemplary embodiment of the present disclosure.

### DETAILED DESCRIPTION

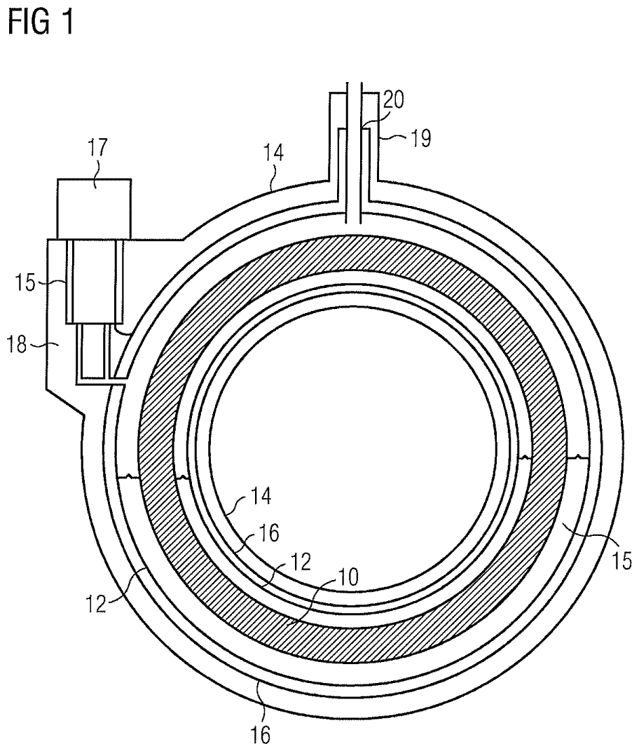

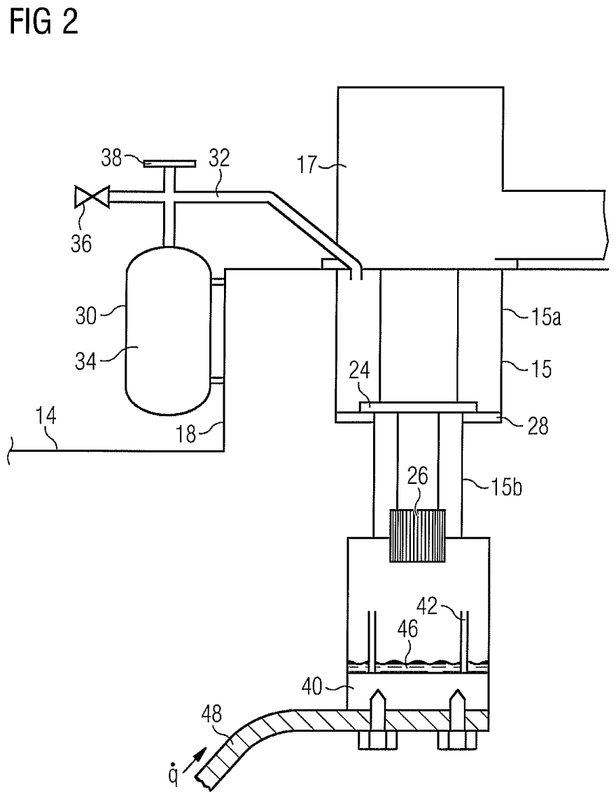

A first exemplary embodiment of the present disclosure is illustrated in FIG. 2. A cryogenic refrigerator 17 is located in refrigerator sock 15 within outer vacuum chamber 14, and in this embodiment within turret 18, as discussed with respect to FIG. 1. In this embodiment, as is conventional in itself, the cryogenic refrigerator 17 is a two-stage refrigerator, having a first stage 24 cooled to a first cryogenic temperature which may be in the range 25-80K. Although not shown in FIG. 2, the first cooling stage 24 may be thermally linked to thermal radiation shield 16, as represented in FIG. 1. The cryogenic refrigerator also has a second stage 26 which cools to a temperature below the boiling point of the cryogen used. In the present description, helium will be used as an example cryogen, although other cryogens may be employed, to provide temperature regulation at a boiling point appropriate for the equipment being cooled. Superconducting magnets for MRI systems are typically manufactured using a superconductor which has a transition temperature close to the boiling point of helium, so helium is a suitable cryogen to use in such cases. Other types of superconductor are known, which have higher superconducting transition temperatures. For equipment containing such other superconductors, other cryogens may be more suitable, for example, hydrogen, or neon.

In the illustrated embodiment, the refrigerator sock 15 includes a first stage thermal intercept 28, in thermal contact with the first stage 24 of the refrigerator. The refrigerator sock 15 may notionally be divided into an upper chamber 15a above the first stage thermal intercept 28, and a lower chamber 15b below the first stage thermal intercept 28. The upper chamber 15a and lower chamber 15b are in fluid communication.

According to a feature of this embodiment of the present disclosure, a cryogen buffer vessel 30 is provided, external to the refrigerator sock 15 and external to the outer vacuum chamber (OVC) 14. A passage 32 links the buffer volume 34 within the cryogen buffer vessel 30 to the interior of the refrigerator sock 15. A valve 36 may be provided to the passage 32 to allow cryogen to be introduced into, and removed from, the buffer volume 34 and the refrigerator sock 15. A burst disc 38 may also be provided, to allow egress of cryogen from the buffer volume 34 and the refrigerator sock 15 in case of an overpressure of cryogen gas. Provision of buffer vessel 30 requires addition of passage 32, which may be selected to be of low thermal conductivity at the appropriate temperature to minimize the associated heat conduction. The passage 32 may be constructed of two or more sections in different materials, each having a low thermal conductivity at the relevant temperature of interest for that section.

According to further features of this embodiment of the present disclosure, the lower chamber 15b is provided with a cold plate 40 and a cryogen gas heat exchanger 42. A quantity of liquid cryogen 46 is present on the cold plate 40, and more generally in the lower chamber 15b. Cryogen gas heat exchanger 42 is in thermal contact with cold plate 40, and protrudes into cryogen gas in the lower chamber 15b above the liquid cryogen 46.

In certain embodiments, it is preferred to provide a textured surface to the cold plate, on the surface which contacts the cryogen. Such texturing has been found to enhance the boiling performance to enable the same rate of transfer of heat energy from the cold plate to the cryogen, with a decreased temperature drop. This means more heat can be extracted whilst keeping the equipment being cooled within its operating temperature range. A “textured” surface may have any surface treatment which increases surface area in contact with liquid cryogen. Examples include surface roughness, protrusions and recesses, fins, slits or holes applied to the surface.

The gas heat exchanger 42 is attached to the cold plate 40 but protrudes above the maximum level of liquid cryogen. This enables heat exchange between the cold plate 40 and cryogen gas, thereby improving cool-down rate particularly when the system is operating with a single-phase, gaseous, cryogen, which will typically be the case during initial cool down while the cold plate 40 and cryogenic refrigerator 17 have not yet cooled to the boiling point of the cryogen 46.

A thermal bus 48 of a thermally conductive material such as aluminum or copper is provided, in thermal contact with the cold plate 40 and in thermal contact with an item to be cooled—not illustrated, but which may for example be a superconducting magnet. A flow of heat energy q proceeds from the item to be cooled to the cold plate, where the heat energy q is removed by boiling of the liquid cryogen 46. Boiled-off cryogen gas circulates within lower chamber 15b and is cooled by the second stage 26 of the cryogenic refrigerator 17. The second stage 26 of the cryogenic refrigerator 17 preferably comprises a heat exchanger of large surface area. For example, the heat exchanger may be finned. The second stage 26 of the cryogenic refrigerator 17 is cooled to a temperature below the boiling point of the cryogen, and cryogen gas is recondensed back into liquid on the surface of the heat exchanger of the second stage 26. The condensed cryogen forms droplets which drip back on to the cold plate.

In addition to boiling of liquid cryogen, some of the heat energy q may be transferred from the cold plate 40 directly to the gaseous cryogen by gas heat exchanger 42, which may take the form of fins attached to the cold plate, which extend above the level of the liquid cryogen.

In normal operation, boiling and recondensation of helium 46 transfers heat energy q from the cold plate 40 to the second stage 26 of the cryogenic refrigerator 17. In this way, heat energy q is drawn from the item to be cooled and a temperature of approximately the boiling point of the cryogen may be maintained at the item to be cooled.

However, in case of failure of the cryogenic refrigerator 17, for example due to failure of a power supply, recondensation of the helium will cease. The liquid helium 46 will boil off, drawing heat energy q from the item to be cooled. As the liquid helium boils, the pressure of cryogen gas within the lower chamber 15b will increase as the total mass of helium present becomes gaseous in form. Some of the mass of cryogen will move into upper chamber 15a as the cryogen gas pressure increases. Similarly, some of the mass of cryogen will flow through passage 32 into the buffer volume 34 of the cryogen buffer vessel 30. Cryogen gas heat exchanger 42 will facilitate transfer of heat energy from cold plate 40 to the cryogen gas, allowing continued cooling of the cooled equipment, to some extent.

When active refrigeration fails, the refrigerator 17 starts to warm by thermal conductivity of its components, which in turn warms the cryogen gas in the refrigerator sock 15. This causes thermal stratification of the cryogen gas in the sock 15 and convective mass flow between the refrigerator 17 and cold plate 40 ceases.

The mass of cryogen provided in the buffer volume 34, passage 32 and free volume within the refrigerator sock 15 is selected so as to provide a useful amount of cooling by boiling, which will last longer than a typical power failure—for example, to last for about ten minutes to one hour. The 5 mass of cryogen required to achieve this cooling will of course depend on the thermal influx to the cryostat. The pressure of the cryogen gas within the cryogen buffer vessel 30 will depend on the dimensions of that vessel, the passage 32 and the free volume in the refrigerator sock 15, and the mass of cryogen 46 present in the cryogen buffer vessel 30, the passage 32 and the 10 refrigerator sock 15. Burst disc 38, where provided, places a safety limit on the pressure of cryogen within the cryogen buffer volume 30, passage 32 and refrigerator sock 15.

Helium has a particularly large thermal expansion, so stratification effects are particularly strong with helium. Due to the large thermal expansion of helium, a relatively small mass of helium will be present in the buffer volume at room temperature during operation, while a significant majority of the mass will remain inside the free volume in the refrigerator sock 15.

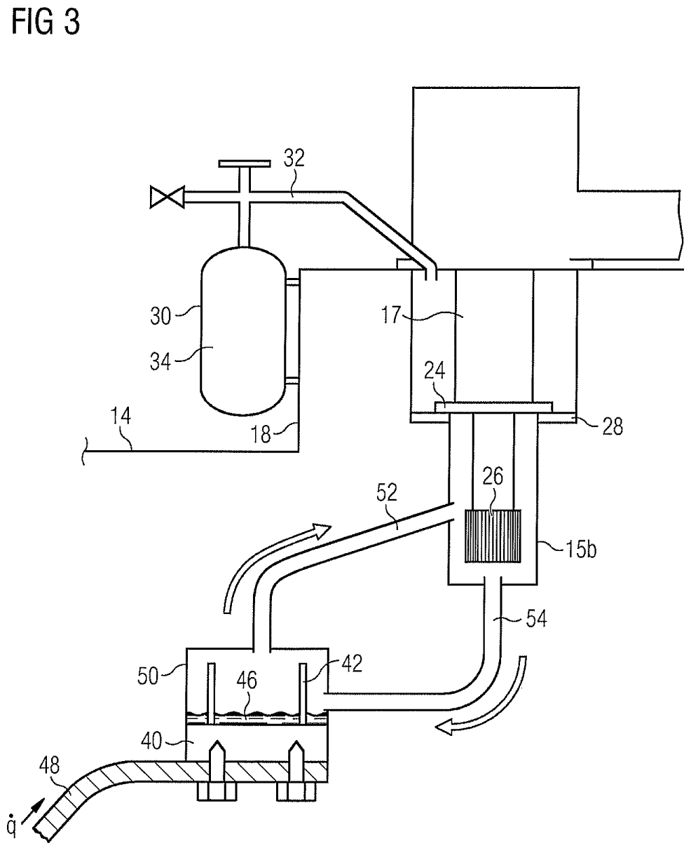

FIG. 3 shows a second embodiment of the present disclosure. In this disclosure, a remote boiling chamber 50 is provided. Remote boiling chamber 50 comprises a cryogen-containing vessel, and includes the cold plate 40, and cryogen gas heat exchangers 42 of the embodiment of FIG. 2.

Cold plate 40 is attached to thermal bus 48 in the same manner as described for FIG. 2. Remote boiling chamber 50 is in fluid communication with lower chamber 15b of refrigerator sock 15 by at least one conduit, preferably an upper pipe 52 and a lower pipe 54. In operation, cryogen gas is condensed to liquid at the second stage 26 of the cryogenic refrigerator 17, and drips down towards the bottom of lower chamber 15b. The liquid cryogen then flows down through lower pipe 54 into the remote boiling chamber 50. There, liquid cryogen enters into contact with cold plate 40. In the manner described with reference to FIG. 2, heat q is extracted from the thermal bus 48 by boiling of the liquid cryogen. The boiled-off cryogen then rises and 5 flows through upper pipe 52 from an upper region of the remote boiling chamber 50 into the lower chamber 15b of the refrigerator sock 15. The boiled-off cryogen is there cooled by the second stage 26 of the cryogenic refrigerator 17 into liquid cryogen which returns through lower pipe 54 to the remote boiling chamber 50. Circulation of cryogen in this way between 10 lower chamber 15b and remote boiling chamber 50 provides transfer of heat q from thermal bus 48 to the cryogenic refrigerator 17.

In embodiments such as shown in FIG. 3, the remote boiling chamber 50 comprising cold plate 40 and recondenser 26 are separated with separate feed and return pipes, upper pipe 52 and lower pipe 54. This improves system efficiency by reducing mixing of cryogen which is being cooled by the cryogenic refrigerator 17 and cryogen which is being warmed by cold plate 40. When active cooling is not available, for instance during failure of a power supply to the cryogenic refrigerator 17, such separation of boiling in the boiling chamber 20 and recondensing at the second stage 26 of the cryogenic refrigerator 17 enhances a thermal switch effect since thermal stratification will occur: colder cryogen will collect in the remote boiling chamber 50 while warmer cryogen will accumulate in the lower chamber 15b of the refrigerator sock 15. Upper pipe 52 and lower pipe 54 constrict cryogen flow between these two components. When active cooling is not available, such thermal stratification reduces thermal conduction between the warming cryogenic refrigerator 17 and the thermal bus 48, and so also the equipment to be cooled. This reduction in thermal conduction contributes towards the ride-through. Separation between remote boiling chamber 50 comprising cold plate 40 and recondenser 26 allows the boiling chamber 50 with cold plate 40 to be located at an optimal point for the required cooling, rather than being constrained by the location of the refrigerator sock 15. Such an arrangement may be found to offer more efficient cooling because heat transport from the cooled equipment to the 5 second stage 26 takes place preferentially by mass flow of cryogen gas, rather than conduction through a thermal bus. In alternative embodiments, the thermal bus 48 may be replaced by a cryogen circuit, in that feed and return cryogen tubes may be provided to circulate cryogen to and from the article to be cooled, i.e. remote boiling chamber 50 can be located at the 10 magnet, which allows shortening of thermal bus 48.

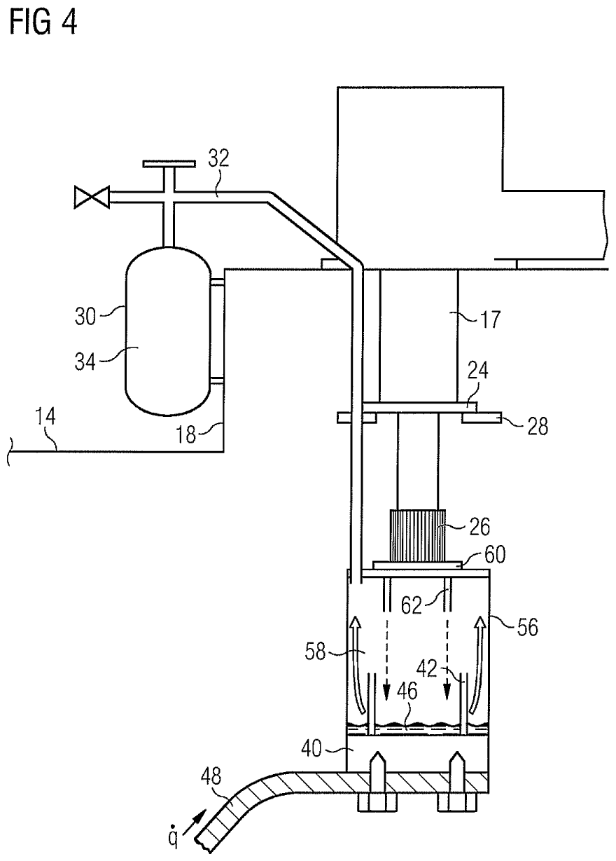

FIG. 4 illustrates a third embodiment of the present disclosure. In this embodiment, the cryogenic refrigerator 17 is not located within a refrigerator sock. Rather, it is partially located within the vacuum space within outer vacuum chamber 14. A boiling unit 56 is provided, in thermal contact with second stage 26 of the cryogenic refrigerator 17. Connection 32 links the buffer volume 34 within cryogen buffer vessel 30 with an interior volume 58 of the boiling unit 56. Boiling unit 56 is thermally joined to the second stage 26 of the cryogenic refrigerator 17 by a thermal joint 60.

Thermal joint 60 may be embodied as a thermal paste, an indium washer, soldered, brazed or direct mechanical contact, between the second stage 26 of the cryogenic refrigerator 17 and an external surface of the boiling unit 56. Within the boiling unit preferably adjacent to the surface which is in thermal contact with the second stage 26 of the cryogenic refrigerator 17, is a condenser heat exchanger 62 in thermal connection with the second stage 26 of the refrigerator. The condenser heat exchanger 62 is a thermally conductive structure of high surface area, for example a finned plate of copper or aluminum.

The boiling unit 56 also comprises cold plate 40 thermally linked to thermal bus 48; and a cryogen gas heat exchanger 42 thermally linked to the cold plate 40, all as described above with reference to the embodiments of FIGS. 2 and 3. In this embodiment, cryogen gas within the boiling unit 52 does not condense on the second stage 26 of the cryogenic refrigerator 17, but rather condenses on the condenser heat exchanger 58 which is cooled by thermal contact with the second stage 26 of the cryogenic refrigerator 17.

In other respects, operation of the embodiment of FIG. 4 is similar to operation of the other described embodiments. Liquid cryogen 46 in contact with cold plate 40 is boiled by heat q drawn from thermal bus 48. The resulting boiled off cryogen rises within the boiling unit 52 due to buoyancy, into contact with condenser heat exchanger 62. The boiled off cryogen recondenses into liquid, and drips back onto the cold plate 40. In addition, cooling of the cold plate 40 may be effected by thermal convection of gaseous cryogen, which draws heat from cryogen gas heat exchanger 42, rises in the boiling unit 56 due to buoyancy, into contact with condenser heat exchanger 62. The cryogen may recondense into liquid, or may be just be cooled. Cooled gas, having an increased density, will descend back into the vicinity of the cryogen gas heat exchanger 42 and the cycle repeats.

It may be noted that the embodiments of FIGS. 2 and 3 do not require a thermal joint 60 to be made between the second stage 26 of the cryogenic refrigerator 17 and an external surface of a boiling unit 56. By locating the cryogenic refrigerator in a gas-filled sock, it is relatively simple to remove and replace the cryogenic refrigerator if required, without the need to make thermal connections between the refrigerator and a boiling unit 56.

In the arrangement of FIG. 4, a boiling unit 56 is provided, independent of the cryogenic refrigerator 17. Since cryogenic refrigerators can tolerate only a limited pressure, it may be found that embodiments of the present disclosure provided with boiling unit 56 may be provided with higher-pressure cryogen within the boiling unit 56 than would be permissible in the case that the cryogenic refrigerator is enclosed in the same cryogen volume. Placement of the cryogenic refrigerator 17 without a refrigerator sock 15 removes a parasitic thermal path otherwise provided by the refrigerator sock 15, and may also reduce the component cost of the system.

In each embodiment, a mass of cryogen is sealed into a volume, that volume being in thermal contact with a coldest stage (26) of a cryogenic refrigerator and equipment to be cooled—which may be linked through a thermal bus. Boiling and recondensation of the cryogen—or heating and recooling of the cryogen in its gaseous form—acts to transfer heat energy from the article to be cooled—or the thermal bus—to the cryogenic refrigerator, in operation. In case of failure of the cryogenic refrigerator, sufficient cryogen mass and sufficient volume is provided that boiling and heating of the resulting cryogen gas is sufficient to maintain the article at an operating temperature for a period of time sufficient to cover a typical failure mode (known as ride-through) such as a failure in mains electricity. Commonly, cryogenic refrigerators are powered by mains electricity and failures in mains electricity tend to last for less than ten minutes.

In all embodiments of the present disclosure, care is taken with design to ensure that the mass of cryogen included in the available volume defined by the cryogen buffer vessel 30, channel 32 and the free volume defined by refrigerator sock 15 or refrigerator sock 15 plus the interior volume of remote boiling chamber 50; or the interior volume of boiling unit 52 is sufficient to provide the required duration of maintaining the cooled equipment at an operating temperature. That duration may be referred to as “ride-through”. The required mass of cryogen is defined by a combination of the available volume and the charge pressure of cryogen at a predetermined temperature.

Typically, the free volume included by the cryogen buffer vessel 30, channel 32 and sock 15 or sock plus remote boiling chamber 50; or boiling unit 52 is in the region of 20-100 liters, and the charge pressure of helium at room temperature is in the region of 4-20 BAR (0.4-2.0 MPa). By adapting the volume, particularly by providing the cryogen buffer vessel 30, the mass of cryogen may be tuned without increasing the design pressure so that the system is still compatible with components which can withstand only a limited pressure range—this may apply particularly to cryogenic refrigerator 17. In embodiments such as shown in FIG. 4, because the cryogenic refrigerator is not exposed to cryogen pressure, the charge pressure of helium at room temperature may be in the region of 4-300 BAR (0.4-30.0 MPa). Because the buffer vessel 30 is at room temperature, it retains very little mass of cryogen when the cryogenic refrigerator 17 is in operation, due to the large thermal expansion of cryogens such as helium.

In alternative embodiments, the buffer vessel may be located elsewhere. The buffer vessel may be located inside the OVC, where it may again be at room temperature, but has the advantage of being protected from damage or tampering; alternatively, the buffer vessel may be located on thermal radiation shield 16, where it will be cooled to an intermediate temperature. Such arrangement has the disadvantage of less efficient use of the cryogen due to reduced temperature of the buffer vessel, but quicker recovery time once active refrigeration re-commences, as it doesn't have to be re-cooled from room temperature.

In each embodiment, the cold plate 40 is positioned below the cryogenic refrigerator. This arrangement enables gas stratification in case of failure of the cryogenic refrigerator 17, thereby reducing heat load into the cooled apparatus in case of failure of the cryogenic refrigerator 17. The embodiment of FIG. 2 shows a single chamber in which vertical separation is provided between cold plate 20 and second stage 26 of the cryogenic refrigerator. The embodiment of FIG. 3, with a remote boiling chamber 50 joined to the refrigerator sock 15 by pipes 52, 54, enables vertical separation to be increased without increasing the available volume.

Preferably, the available cold volume is optimized to give maximum working temperature range and thermal inertia. The “cold volume” is the volume of the lower chamber 15b of the refrigerator sock 15, and linked cryogen-filled volumes below that lower chamber. A certain mass of cryogen in gaseous state does not contribute as much thermal inertia as the same mass of liquid cryogen in case of failure of the cryogenic refrigerator, but will expand on warming towards room temperature and so will require a large buffer volume 34 and/or will produce a high pressure within the buffer volume when warmed to room temperature. The arrangement of the present disclosure, in use, preferably contains an appropriate mass of liquid cryogen 46 to provide an appropriate “ride-through”—that is, duration of maintenance of an operating temperature of the cooled article in the absence of active refrigeration—with a minimal volume of gaseous cryogen which offers much less thermal inertia since it cannot absorb latent heat of evaporation to provide cooling. Minimizing of volume of gaseous cryogen may be contributed to in embodiments such as shown in FIGS. 2 and 3 by shaping of the refrigerator sock 15 to closely conform to the shape of the cryogenic refrigerator 17. In the embodiment of FIG. 3, use of upper pipe 52 and lower pipe 54 provide some control over free volume. Minimizing free volume is believed to be especially important in the lower chamber 15b in which the second stage 26 of the cryogenic refrigerator 17 is located. This is because the gas density is greater in the lower chamber, and gas in the lower chamber will expand on refrigerator failure to require a large buffer volume, or will produce a high pressure in the buffer volume when warmed to room temperature.

The fully sealed nature of the arrangement of the present disclosure allows it to operate at sub-atmospheric pressure under normal conditions, which increases the ride-through when cooling fails even further. While some conventional arrangements operate with a cryogen pressure of 101-120 kPa absolute at a temperature of 4.22K-4.38K, the arrangement of the present disclosure could be run at a pressure in the range 24-101 kPa absolute at a temperature of 3.15K-4.22K, which provides improved ride-through. The buffer volume 34 and the free volume within the channel 32, refrigerator sock 15 or boiling unit 52 or refrigerator sock 15 and remote boiling chamber 20 are optimized such that the disclosure operates as a sealed unit, wherein a correct mass density of cryogen is provided such that liquid is formed when cold, so that two-phase operation may be employed to give high heat transport efficiency, and that enough liquid cryogen is formed to provide a useful ride-through duration that can maintain the cooled equipment at an operational temperature in case of failure of the active refrigeration by boiling of the liquid cryogen.

In certain embodiments, extra vertical separation is provided between the boiling location, at the cold plate 40, and the recondensing location at the second stage 26, either by extending the chamber as in FIG. 2 or separating into two chambers with pipe connections as in FIG. 3 to minimize heat influx in case of failure of active refrigeration. Such arrangements may be found to reduce heat influx from around 2-5 W to less than 0.2 W. This then contributes to increased ride-through.

The present disclosure accordingly provides a fault-tolerant cryogenically cooled system as described above and as recited in the appended claims, in which a mass of cryogen is sealed into a volume and is cooled by a cryogenic refrigerator and acts by evaporation and recondensation to transfer heat energy from cooled equipment to a second stage 26 of a cryogenic refrigerator 17.

Other partial solutions are known for increasing the ride-through of a cryogenically cooled system. Generally, such other partial solutions may be applied in conjunction with the arrangement of the present disclosure. For example, measures may be taken to minimize heat loads into the cryostat, so that the rate of temperature rise of the cooled equipment is minimized during the ride-through. Such measures may be employed in addition to the present disclosure. Thermal paths which introduce heat into the cryostat may be interrupted when active refrigeration is unavailable, for example by using thermal switches, by disconnecting current leads to cooled equipment, by removing the cryogenic refrigerator or at least moving it out of thermal contact with cooled equipment. These measures may usefully be employed in conjunction with the present disclosure.

Another type of arrangement known for increasing the tolerance of a cryostat to failure of the power supply for active refrigeration lies in the provision back-up power generator or battery, which is brought into service to power the cryogenic refrigerator in case of failure of the primary power supply. Such arrangements may of course be employed in conjunction with the present disclosure, such that the arrangement of the present disclosure only comes into operation in case such back-up power generator or battery should fail or become exhausted.

Throughout the present description, references to “second stage” of the cryogenic refrigerator are to be understood as meaning a heat exchanger thermally linked to the coldest cooling stage of the refrigerator. Cryogenic refrigerators currently commonly have two stages, but the present disclosure may be applied to refrigerators having more, or fewer, than two stages, and the term “second stage” as used herein should be taken to mean the coldest stage of the cryogenic refrigerator.

1-12. (canceled)

13. A fault-tolerant cryogenically cooled system, comprising:
an outer vacuum chamber defining a vacuum region in its interior volume;
a cryogenic refrigerator;
equipment to be cooled, housed within the vacuum region;
a free volume delimited within the vacuum region and containing a cryogen;
a cold plate exposed to the free volume and thermally linked to the equipment to be cooled;
a heat exchanger thermally linked to a coldest stage of the cryogenic refrigeratorand exposed to the free volume;
a cryogen buffer vessel delimiting a buffer volume; and
a passage linking the buffer volume with the free volume,
wherein the cryogen buffer vessel and the passage are arranged such that, during failure of the cryogenic refrigerator, some of the mass of cryogen will flow through the passage into the buffer volume of the cryogen buffer vessel.

14. A fault-tolerant cryogenically cooled system according to claim 13, wherein the cryogen buffer vessel is external to the outer vacuum chamber.

15. A fault-tolerant cryogenically cooled system according to claim 13, wherein the cryogen buffer vessel is internal to the outer vacuum chamber.

16. A fault-tolerant cryogenically cooled system according to claim 13, wherein the cryogen buffer vessel is internal to the outer vacuum chamber, thermally linked to a thermal radiation shield provided in a vacuum space between a cryogen vessel and the outer vacuum chamber.

17. A fault-tolerant cryogenically cooled system according to claim 13, wherein an upper surface of the cold plate is textured.

18. A fault-tolerant cryogenically cooled system according to claim 13, wherein the cold plate is provided with a cryogen gas heat exchanger in thermal contact with the cold plate.

19. A fault-tolerant cryogenically cooled system according to claim 18, wherein the cryogen gas heat exchanger comprises fins attached to the cold plate.

20. A fault-tolerant cryogenically cooled system according to claim 13, further comprising:
a thermally conductive thermal bus in thermal contact with the cold plate and in thermal contact with equipment to be cooled.

21. A fault-tolerant cryogenically cooled system according to claim 13, wherein the cryogenic refrigerator is a two-stage refrigerator, and the heat exchanger is cooled by a second stage of the cryogenic refrigerator.

22. A fault-tolerant cryogenically cooled system according claim 13, wherein the cryogenic refrigerator is partially accommodated within a refrigerator sock which is within the vacuum region, the interior of the refrigerator sock defining the free volume in conjunction with the cold plate.

23. A fault-tolerant cryogenically cooled system according to claim 13, wherein the cryogenic refrigerator is partially accommodated within a refrigerator sock which is within the vacuum region, the interior of the refrigerator sock is in fluid communication with the interior of a remote boiling chamber comprising a cryogen-containing vessel and the cold plate, and the free volume comprising the interior of the refrigerator sock, the interior of the remote boiling chamber, and the interior of the fluid communication between them.

24. A fault-tolerant cryogenically cooled system according to claim 13, wherein the cryogenic refrigerator is partially accommodated within the vacuum region, the coldest stage of the refrigerator sock is in thermal connection with a heat exchanger exposed to the interior volume of a boiler comprising a cryogen-containing vessel and the cold plate, and the free volume comprising the interior volume of the boiler.
